(19) United States
(12) Patent Application Publication
(10) Pub. No.: US 2025/0221474 A1
(43) Pub. Date: Jul. 10, 2025

(54) Heating Device

(71) Applicant: Kozy Holdings LLC, Bainbridge Island, WA (US)

(72) Inventors: Nathaniel Durrance, Bainbridge Island, WA (US); Michael Maddie, Bainbridge Island, WA (US); Ben Bounketh, Bainbridge Island, WA (US); Damien Lawson, Bainbridge Island, WA (US)

(21) Appl. No.: 18/854,349

(22) PCT Filed: Mar. 7, 2023
(86) PCT No.: PCT/US2023/014756

§ 371 Date: Oct. 4, 2024

(51) Int. Cl. A41D 13/005; H05B 1/02

(52) U.S. Cl. CPC A41D 13/0051; H05B 1/0272

(57) ABSTRACT

A heating device is disclosed that hangs around a user's neck and provides heat to at least a portion of the user's neck and core areas of the body (e.g., chest or back) and provides functionality through an electronic unit that controls the heat and provides power and other various functionalities.

### CROSS-REFERENCE TO RELATED APPLICATION

This application is a National Stage Entry of International Application No. PCT/US23/14756, filed Mar. 7, 2023, which claims priority and benefit to U.S. Provisional Application No. 63/294,059, filed on Mar. 7, 2022 and titled Heating Device, the contents of which are incorporated herein by this reference as though set forth in their entirety.

### FIELD OF USE

Heating device designed to be worn by a user.

### BACKGROUND

Various heating devices exist, but no heating device is designed to heat the core portion of your body, namely a person's chest and neck area. There exists a need for a device that is able to effectively heat a person's core, principally around the outside area of the body where a person's heart, lungs, and blood flow originates from—namely the human chest and neck area.

### SUMMARY OF THE DISCLOSURE

A heating device is disclosed comprising a first elongated portion configured to hang around a human's neck and heat up the human's neck and core chest area of the body, a second portion within the first portion configured to receive power and provide heat within the first portion, a third portion configured to provide and control the power provided to the second portion. In embodiments, the third portion is a control unit comprising: a power unit, a computer unit, and a user control unit. In embodiments, the power unit comprises rechargeable batteries or disposable batteries. In embodiments, the computer unit comprises a microcontroller configured to control the power output to the second portion. In embodiments, the amount of power delivered to the second portion by the microcontroller is configured to control the amount of heat delivered by the heating device. In embodiments, the heating device has a shutoff if the heat reaches a threshold maximum level. In embodiments, the user control unit comprises buttons that control the heating devices heat level and comprises displays that indicate power level and heat level. In embodiments, the user control unit further comprises a Bluetooth communication unit configured to communicate with a user's remote device and permit user control over the unit via the user's remote device. Other embodiments and configurations are possible.

Still other advantages, embodiments, and features of the subject disclosure will become readily apparent to those of ordinary skill in the art from the following description wherein there is shown and described a preferred embodiment of the present disclosure, simply by way of illustration of one of the modes best suited to carry out the subject disclosure. As will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The accompanying drawings, which are incorporated in and constitute a part of this specification, illustrate embodiments of the disclosure and together with the general description of the disclosure given above and the detailed description of the drawings given below, serve to explain the principles of the disclosure. In certain instances, details that are not necessary for an understanding of the disclosure or that render other details difficult to perceive may have been omitted.

FIG. 1 generally illustrates a heating device according to a first embodiment.

FIG. 2 generally illustrates a heating device according to a first embodiment.

FIG. 3 generally illustrates a heating device according to a second embodiment.

FIG. 4 generally illustrates a heating device according to a second embodiment.

FIG. 5 generally illustrates a heating device according to a third embodiment.

FIG. 6 generally illustrates a heating device according to a third embodiment.

FIG. 7 generally illustrates a heating device according to a fourth embodiment.

FIG. 8 generally illustrates a heating device according to a fourth embodiment.

FIG. 9 generally illustrates a heating device according to a fifth embodiment.

FIG. 10 generally illustrates a heating device according to a fifth embodiment.

FIG. 11 generally illustrates a heating device according to a sixth embodiment.

FIG. 12 generally illustrates a heating device according to a sixth embodiment.

FIG. 13 generally illustrates a heating device and stitching according to a first embodiment.

FIG. 14 generally illustrates a heating device and stitching according to a first embodiment.

FIG. 15 generally illustrates a heating device and stitching according to a second embodiment.

FIG. 16 generally illustrates a heating device and stitching according to a second embodiment.

FIG. 17 generally illustrates a heating device and stitching according to a third embodiment.

FIG. 18 generally illustrates a heating device and stitching according to a third embodiment.

FIG. 19 generally illustrates a heating device and stitching according to a fourth embodiment.

FIG. 20 generally illustrates a heating device and stitching according to a fourth embodiment.

FIG. 21 generally illustrates a heating device and stitching according to a fifth embodiment.

FIG. 22 generally depicts an embodiment of a circuit configured to provide controlled heat to the heating device.

FIG. 23 depicts embodiments of a high-performance control signal configured to provide a controlled heat signal to the heating device depending on the difference between the target temperature of the heating device desired by the user and the current temperature of the heating device.

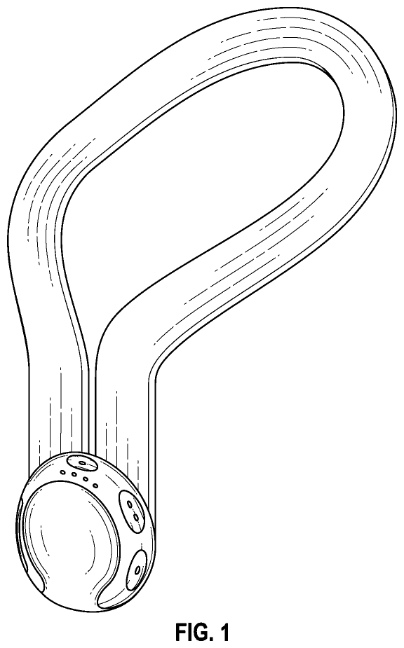

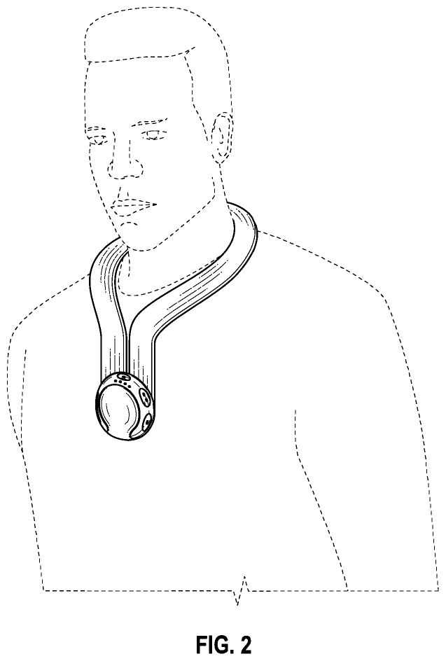

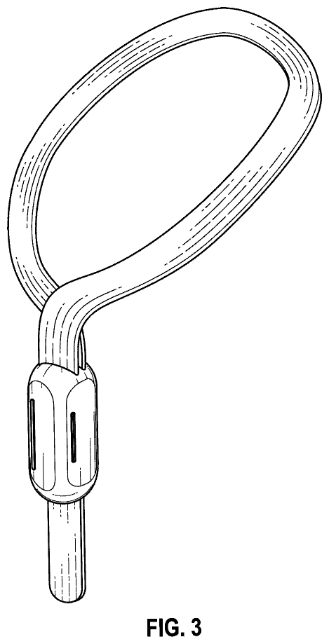

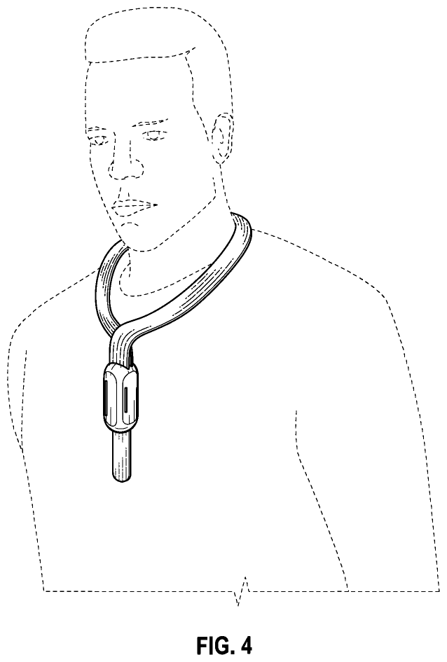

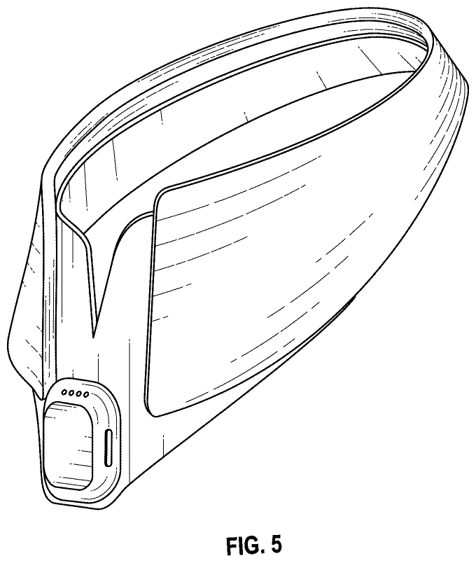

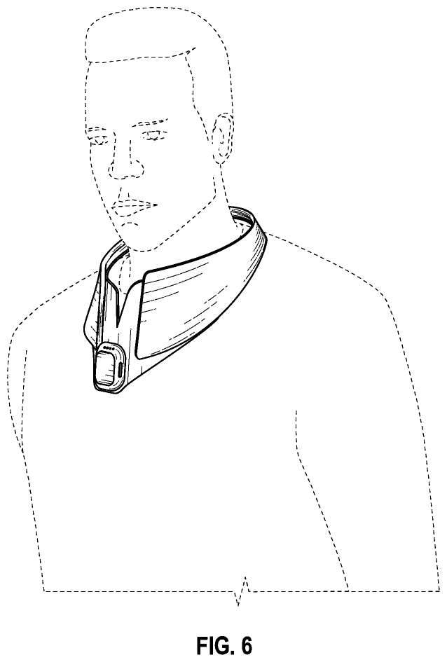

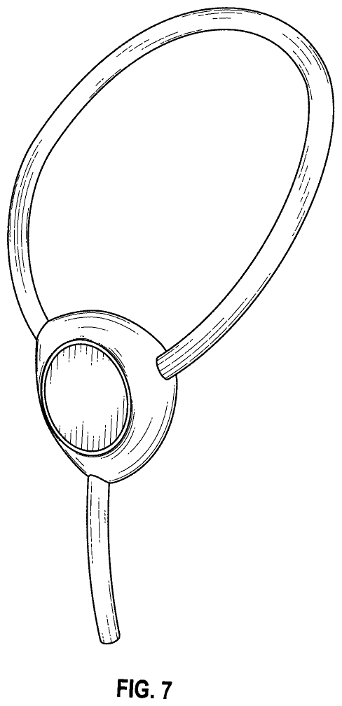

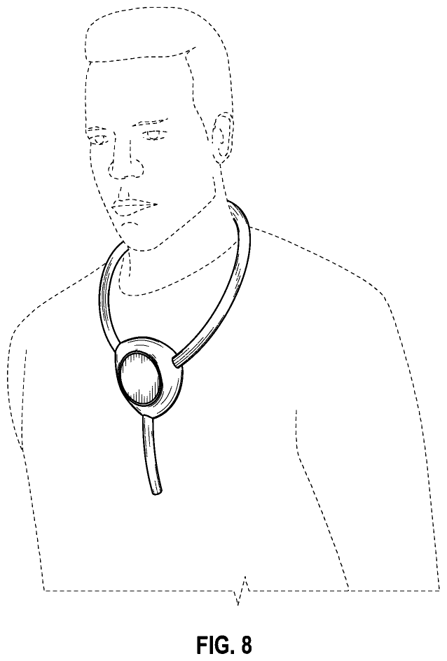

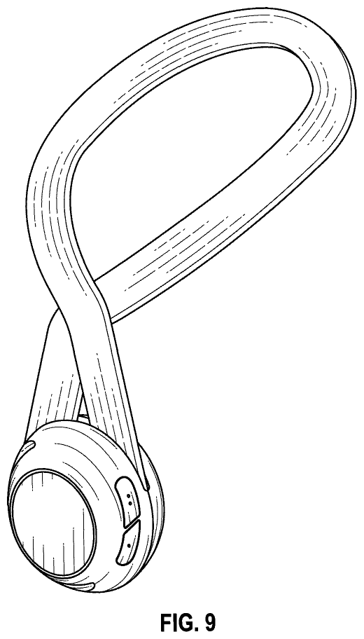

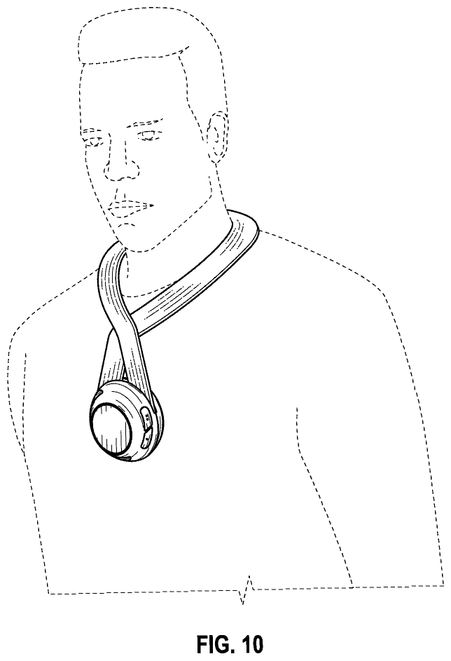

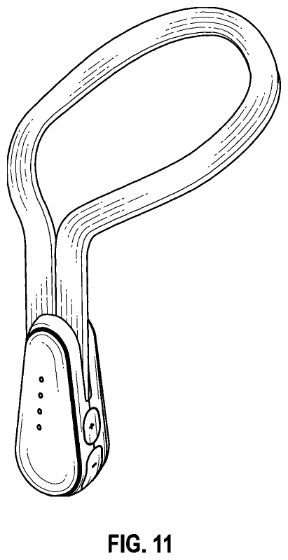

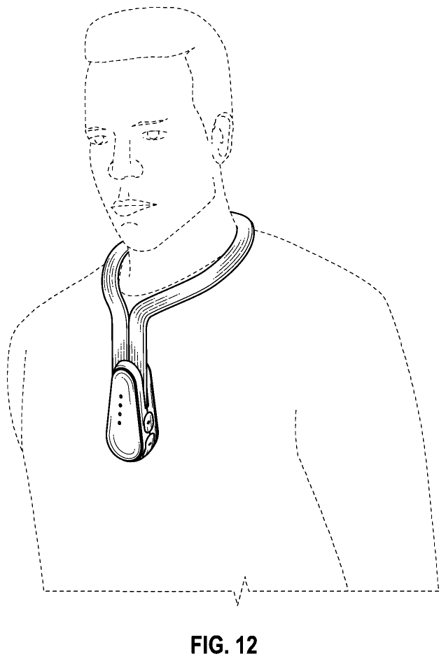

### DETAILED DESCRIPTION OF EMBODIMENTS

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

A heating device is disclosed comprising a first elongated portion configured to go around a human's neck and heat up the human's neck and core chest area of the body, a second portion within the first portion configured to receive power and provide heat within the first portion, a third portion configured to provide and control the power provided to the second portion. In embodiments, the third portion is a control unit comprising: a power unit, a computer unit, and a user control unit. In embodiments, the power unit comprises rechargeable batteries or disposable batteries. In embodiments, the computer unit comprises a microcontroller configured to control the power output to the second portion. In embodiments, the amount of power delivered to the second portion by the microcontroller is configured to control the amount of heat delivered by the heating device. In embodiments, the heating device has a shutoff if the heat reaches a threshold maximum level. In embodiments, the user control unit comprises buttons that control the heating devices heat level and comprises displays that indicate power level and heat level. In embodiments, the user control unit further comprises a Bluetooth communication unit configured to communicate with a user's remote device and permit user control over the unit via the user's remote device. Other embodiments and configurations are possible.

Various embodiments of the heating device include the following: a low heat mode button, a high heat mode button, a main power button, a USB socket (USB-C), and an LED indicator of power and heat.

Other embodiments include a first elongated portion that is a band that hangs on a user's neck and drape down over at least a portion of the user's chest. In embodiments, the heating device goes around a user's neck and is configured to provide heat to at least the neck area. In other embodiments, the heating device is configured to drape over a user's neck and then hang over at least a portion of the user's chest or back area, thereby heating the user's neck, chest, and/or back. In embodiments, the band is bisected and is fastened around a user's neck with an adjustable Velcro attachment or an adjustable clip. In other embodiments, the first elongated portion is a continuous band that is fastened at the end by the third portion with a clasp or a magnet.

In the Figures, the first elongated portion is the part that hangs around the user's neck and that hangs over the user's chest (or back area), thereby heating the user's core by providing heat to critical areas of the body, such as the heart, lungs and circulatory system. In embodiments, the second portion is the heating element within the first elongated portion (see FIGS. 14, 16, 18, 20 and 21), wherein the heating element can be configured in embodiments to provide heat to just a portion of the heating device, such that heat can be limited to the neck area, limited to the chest or back area, or be delivered throughout the entire heating device, thereby providing heat to all areas where the heating device is located. The heating element in the middle portion of the first elongated portion is depicted as a round cross section, but the heating element can be of any cross section that fits within the elongated first portion. In embodiments, the heating element is connected to and controlled by the third portion, which is a control unit in embodiments comprising a microcontroller that responds to a user raising or lowering the amount of heat that is to be delivered to the heating element by the power of the control unit.

In the Figures, the first elongated portion is the part that hangs around the user's neck (and in embodiments that covers at least a portion of the user's neck, shoulders, chest, back, or core areas), the second portion is the heating element within the first elongated portion (see FIGS. 14, 16, 18, 20 and 21). The heating element in the middle portion of the first elongated portion is depicted as a round cross section, but the heating element can be of any cross section that fits within the elongated first portion. In embodiments, the heating element is connected to and controlled by the third portion, which is a control unit in embodiments comprising a microcontroller that responds to a user raising or lowering the amount of heat that is to be delivered to the heating element by the power of the control unit.

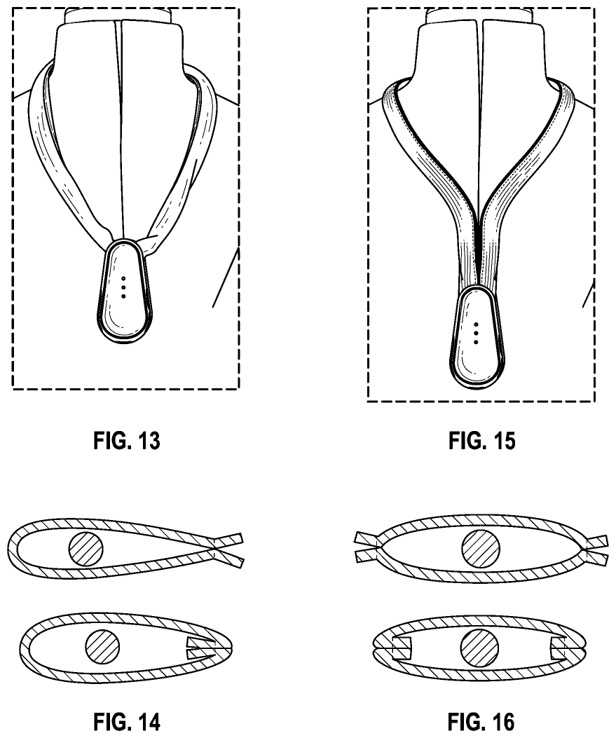

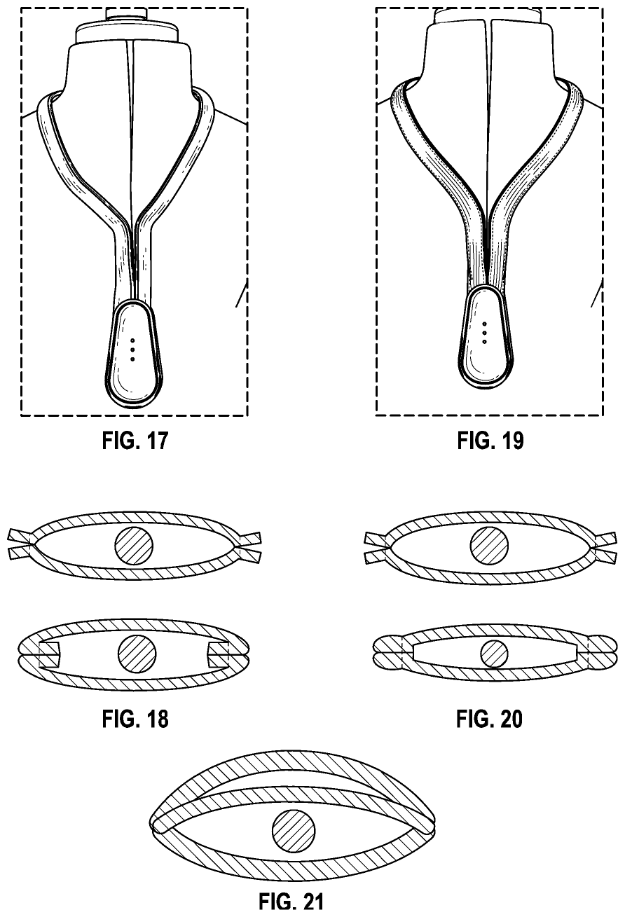

In embodiments, the first elongated portion is sewn in a way to provided single stitching (FIGS. 13 and 14) or double stitching (FIGS. 15-20). In embodiments with the single stitching, a single seam is sewn enclosing a heating element inside (FIGS. 13 and 14). In embodiments having double stitching, multiple layers of fabric can be used to create an intentional geometry and apply different materials to the top and bottom assembly of the first elongated portion (FIGS. 15-20). In embodiments, the first elongated portion does not have a top stich (FIGS. 17-18). In other embodiments, the first elongated portion comprises a top stich (FIGS. 19-20), which flattens the edges of the first elongated portion to make it lay flatter and more directional. In embodiments, the first elongated portion comprises a reflective layer inside the first elongated portion (FIG. 21, area directly above circular heating cable). In these embodiments, the reflective layer helps maximize the amount of heat delivered to a user by the device. In other embodiments, the first elongated portion comprises a conductive fabric (FIG. 21, area directly below circular heating cable) that is sewn on the side that touches a user's skin.

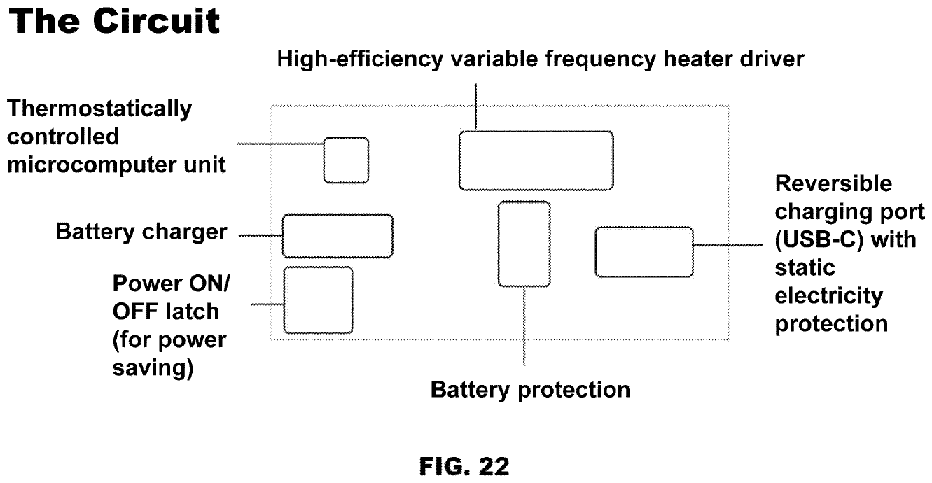

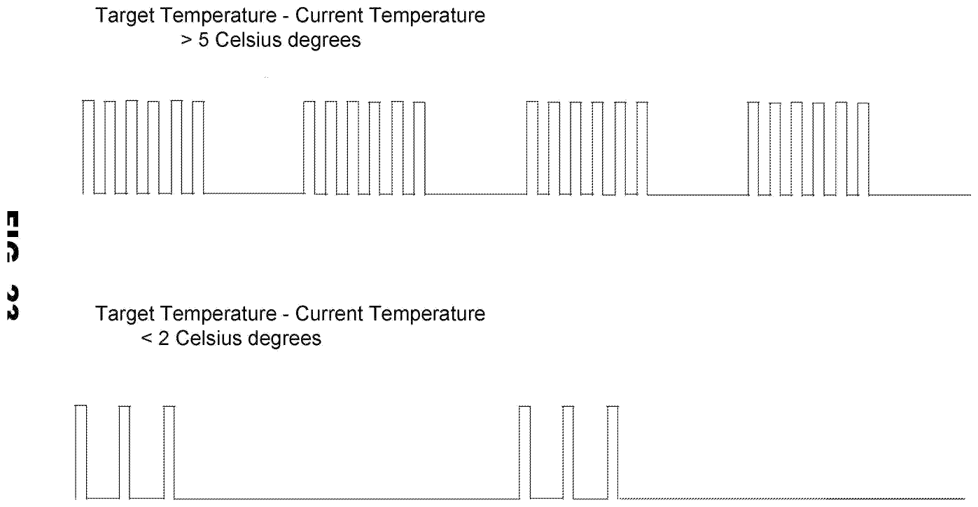

In various embodiments, as shown in FIG. 22, a heating device described herein comprises a circuit comprising various electrical components, including but not limited to the following: a thermostatically controlled microcomputer unit, a high-efficiency variable frequency heater driver, a reversible charging port (e.g., USB-C) with static electricity protection, a power on/off switch (for power saving, if desired), and a battery charger and battery protection circuitry (if desired).

In embodiments, the heating device comprises a thermostatically controlled microcomputer unit that is configured to generate a signal to control the power provided to the heating element of the heating device, thereby providing control over the heating efficiency of the heating device. The thermostatically controlled microcomputer unit can monitor temperature of the heating element (e.g., via a temperature sensor) and adjust the heat level (or duration power) that is provided to the heating element, thereby providing control over the level and duration of power provided to the heating element, and therefore providing control over the level and duration of heat that will emanate from the heating device to the user's core and other body parts near the heating device. For example, in embodiments, the thermostatically controlled microcomputer unit has a microcontroller that is configured to monitor the detected temperature of the heating element using a thermal sensor (or the detected temperature of another desirable portion of the heating device, such as the core area of the user's body over which the heating device is hanging) and adjust the heating power provided to the heating element to reach the desired heating level (or temperature range) set by the user. When the microcontroller detects the thermal sensor reaching the target or desired temperature, the microcontroller will send a signal to slow down or stop the output power to the heating element. In embodiments, the microcontroller unit is configured with a user controller where the user can set the desired heating level of the heating device (for example, a low, medium or high settings of temperature generation that a user wants), the timing of the power sent to the heating element (for example, setting a 5, 10, 15, 30, or 60 minute timer for the heating device to provide power to the heating element and therefor heat to the user's core areas near the heating device). In embodiments, the microcontroller unit is configured with a circuit that will monitor the battery level and provide feedback to a user regarding the power or energy level of the battery, for example alerting the user when the battery is low or full.

In embodiments, the heating device comprises a high-efficiency variable frequency heater driver configured with a high-efficiency voltage converter and a fast response load switch. In embodiments, the heater driver is configured with a voltage regulator that can convert voltage into a suitable level of voltage for delivery to the heating element to provide an appropriate amount of power to the heating element to provide for the user's desired level of heat or temperature. In embodiments, a load switch within the heater driver is configured to receive a signal from the microcontroller and react as a controlled switch to regulate output power to the heating element. In embodiments where an output power from the microcontroller is not high enough to deliver sufficient energy to the heating element to reach the desired temperature, an amplify driver circuit is provided to amplify the power signal. In embodiments with a driver circuit, the heating device is able to more efficiently provide power to the heating element and is able to respond quicker to the microcontroller when temperature settings are changed by the user.

In embodiments, the heating device comprises a reversible charging port (e.g., USB-C) with static electricity protection. In these embodiments, a type C port allows either direction of type C cable insertion, thereby facilitating a user connecting to a type C power source more readily. Also, in embodiments, a static protection circuit helps prevent electrostatic discharge (ESD) damage from the surrounding environment. In embodiments, the type C connector is used as a charging input port for the heating device and the connector has an integrated circuit (IC) configured to prevent ESD from either the user side or cable side.

In embodiments, the heating device comprises a battery protection unit configured to help protect a battery of the heating device from over-charge and over-dis-charge. In embodiments, the battery protection unit has a battery protection circuit configured to provide protection to battery. For example, when a battery protection unit detects that a battery is under abnormal conditions, such as over loading, over voltage, over dis-charge, the battery protection unit it will turn off the circuit (and therefore turn off the power to the heating element) to prevent further damage to the battery. In embodiments, when a temperature sensor of the heating device detects an extreme temperature in the device (such as in the heating element), the protection circuit will shut off the circuit (and therefore cutting off or reducing the power provided to the heating element) to protect the battery from further damage and to protect the user from overheating or burning.

In embodiments, the heating device comprises a power on/off latch for power saving. In these embodiments, the power on/off latch circuit permits a user to control the on/off power of the device and thereby help control the amount of power being consumed by the device and extending the battery life. In these embodiments, the power on/off latch is configured to work with the micro-controller circuit, such that when the power latch is turned off, the device power is shut off and there is no signal output from the microcontroller to maintain on, so the switch will keep the signal output off, and the device will consume no power. When the power latch is turned on, the microcontroller unit is provided power and will turn on, and in turn, the powered microcontroller will send a signal to heater driver to provide power to the heating element appropriate for the difference between the desired temperature setting and the current temperature detected by the heat sensor. In embodiments, when the power latch (or power button) is turned on and the microcontroller is powered, the microcontroller has sufficient power to send a signal to the power switch to keep it at the on position, so the heating device is able to receive power (when needed) in the on state.

In embodiments, the heating device comprises a battery charger circuit configured to convert power into a suitable voltage for the heating device's battery to charge and to control the battery's charging. In embodiments, the battery charger circuit comprises an IC to detect a battery level (or charging level) of the battery and to adjust the voltage provided to the battery such that the battery is charged safely.

In embodiments, the heating device is also configured with energy storage options to support powering of the heating device, including but not limited to both built-in, and external mechanisms (e.g., lithium polymer, AA, AAA, portable charger, and other battery types). For example, in one embodiment, the heating device is configured with an integrated rechargeable lithium polymer or ion battery. In another embodiment, the heating device is configured with an integrated alkaline battery that can be replaced (AA, AAA or other replaceable battery). In another embodiment, the heating device is configured with a port (e.g., USB of any type) that can accept power from standard power banks.

In embodiments, with the various configurations, a heating device is provided that is configured to provide at least 4 hours of continuous heat, preferably 5-6 hours of continuous heat. In embodiments, the heating device provides a maximum temperature output of 30 degrees.

In embodiment, the heating device is designed to be worn under a user's clothes and provide heat to the front of the user's chest (i.e., the core body) and behind the neck. In other embodiments, the heating device is configured to provide heat to the user's upper back as well. In other embodiments, the heating device is configured with waterproof or water-resistant materials, thereby protecting the electrical and heating components from moisture.

In embodiments, a heating device described herein is designed to provide a desired amount of heat to a user's core areas where heat is desired, including one or more of the user's neck, upper chest (near the heart and lungs) and upper back areas. In embodiments, a thermostatically controlled microcomputer unit is configured to get the proper heat to the user and to the proper areas of the body (depending on settings fixed by the user, energy level of the battery, ambient temperature, and pre-set heating controls within the microcontroller). In embodiments, a heating element is spread inside of a fabric, which will cover the user's neck and chest areas. When power is turned on for the heating device, and a user sets a target temperature (or a target temperature is pre-set), a microcontroller detects a low temperature from the heating element area (via a temperature sensor) and will start heating up the heating element faster to reach the target temperature. When the detected temperature is approaching the target temperature, the microcontroller will slow down the rate at which power is provided to the heating element to maintain the detected temperature in a desired range close to the target temperature (e.g., within a few degrees, or within a set range like 5 degrees, of the target temperature).

In embodiments of the heating device, a thermostatically controlled microcomputer unit and high-efficiency variable frequency heater driver circuit work together as depicted in FIGS. 22 and 23. The microcontroller is configured with programming to build up a reverse correlation between a temperature delta and a heating speed. When heating, the microcontroller will adjust a frequency and duration of a control signal sent to a driver circuit. For example, as depicted in FIG. 23, a high-performance control signal has a greater frequency or duration (or both) because the target temperature is greater than 5 degrees below the current temperature detected by a temperature sensor on the heating device. Also as an example, as depicted in FIG. 23, a high performance control signal has a lower frequency or duration (or both) because the target temperature is less than 2 degrees below the current temperature detected by a temperature sensor on the heating device. Thus, when the target temperature is greater than 5 degrees (or other target differential set in the microcontroller), the microcontroller sends power to the heating element at a greater frequency and duration to warm the heating element up faster. In contrast, when the target temperature is less than 2 degrees (or other target differential set in the microcontroller), the microcontroller sends power to the heating element at a lesser frequency and duration because the target temperature is reached (or nearly reached) and the heating device does not require power, thus saving on power consumption and preventing overheating of the user. In embodiments, the high-efficiency variable frequency heater driver is configured with a wide bandwidth to allow for fast switching speed between low and high-power settings. For example, in embodiments, the microcontroller of the heating device is configured to detect a battery level and to display to the user the power level of the battery. In embodiments, the heating device is configured with a high and a low temperature setting switch, wherein a microcontroller is configured to set the target temperature of the heating element on high or low depending on whether the switch is either on a high or low setting, respectively.

In embodiments, to ensure a small device profile, especially since it is meant to be worn around a user's neck and rest on a core area of the body, the device is designed to be slim yet still have enough desirable battery life (e.g., enough power to heat a user's core for at least a few hours). for a user. In these embodiments, an enclosure for the electronics and battery of the heating device is optimized to have a minimal profile with a minimized PCB.

With these various configurations, the heating device described herein is the only device that is designed to heat a user's core (not just the neck), and moreover, to heat the user's core in a completely unique fashion with a heat control signal that prolongs battery life and keeps the user at an optimal temperature. For example, in embodiments, the heating device can be controlled by the user (or preset during fabrication) to provide power (and therefore heat) to only a portion of the heating element. For example, in embodiments, the heating device can be set to only provide power and resulting heat to portions of the heating element around the user's neck, or just to the portions of the heating element close to the user's core, or just to the user's back, or some combination thereof.

Other embodiments may include combinations and sub-combinations of features described or shown in the several figures, including, for example, embodiments that are equivalent to providing or applying a feature in a different order than in a described embodiment; extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, “feature” or “features” can refer to structures and/or functions of an apparatus, article of manufacture or system, and/or the steps, acts, or modalities of a method.

References throughout this specification to “one embodiment,” “an embodiment,” “an example embodiment,” etc., indicate that the embodiment described may include a particular feature, structure, or characteristic, but every embodiment may not necessarily include that particular feature, structure, or characteristic. Moreover, such phrases are not necessarily referring to the same embodiment. Further, when a particular feature, structure, or characteristic is described in connection with one embodiment, it will be within the knowledge of one skilled in the art to affect such feature, structure, or characteristic in connection with other embodiments whether or not explicitly described.

Unless the context clearly indicates otherwise (1) the word “and” indicates the conjunctive; (2) the word “or” indicates the disjunctive; (3) when the article is phrased in the disjunctive, followed by the words “or both,” both the conjunctive and disjunctive are intended; and (4) the word “and” or “or” between the last two items in a series applies to the entire series.

Where a group is expressed using the term “one or more” followed by a plural noun, any further use of that noun to refer to one or more members of the group shall indicate both the singular and the plural form of the noun. For example, a group expressed as having “one or more members” followed by a reference to “the members” of the group shall mean “the member” if there is only one member of the group.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

What is claimed:

1. A heating device comprising: a first elongated portion configured to go around a human's neck and selectively heat in a controlled fashion at least a portion of the human's core chest area, a second portion within the first portion configured to receive power and provide heat within the first portion, a third portion configured to provide and control the power provided to the second portion.

2. The heating device of claim 1, wherein the third portion is a control unit comprising: a power unit, a computer unit, and a user control unit.

3. The heating device of claim 2, wherein the power unit comprises rechargeable batteries.

4. The heating device of claim 3, wherein the power unit comprises disposable batteries.

5. The heating device of claim 2, wherein the computer unit comprises a microcontroller configured to control the power output to the second portion.

6. The heating device of claim 5, wherein the amount of power delivered to the second portion by the microcontroller is configured to control the amount of heat delivered by the heating device.

7. The heating device of claim 6, wherein the heating device has a shutoff if the heat reaches a threshold maximum level.

8. The heating device of claim 2, wherein the user control unit comprises buttons that control the heating devices heat level.

9. The heating device of claim 2, wherein the user control unit comprises displays that indicate power level and heat level.

10. The heating device of claim 2, further comprising a Bluetooth communication unit configured to communicate with a user's remote device and permit user control over the unit via the user's remote device.

11. The heating device of claim 2, wherein the first elongated portion is configured to heat at least a portion of the human's neck, chest, or back areas.

12. The heating device of claim 2, wherein the first, second and third portions of the heating device are configurable to provide heat to selectable portions of the heating device, wherein the selectable portions can be a portion of the human's neck, a portion of the human's chest, a portion of the human's back, a portion of the human's core, or a combination of those portions.

13. A heating device configured to heat a user's core by hanging around a user's neck and resting against a user's upper chest area, the device comprising a heat control signal that is configured to provide heat to the device at a controlled interval dependent on a differential between a measured temperature from a probe and a temperature setting chosen by the user.

14. A heating device configured to hang around a user's neck and provide heat to a central core portion of the user's body, the device comprising: a thermostatically controlled microcomputer unit, a variable frequency heater driver, a power source, and a heating element configured to receive power and provide heat wherein the heating element is configured to rest against and provide heat to at least a portion of the user's central core portion of their body.

15. The ornamental design for a heating device as shown and described.
